(19) United States
(12) Patent Application Publication
(10) Pub. No.: US 2023/0072643 A1
(43) Pub. Date: Mar. 9, 2023

(54) Door strike allowing vertical adjustment

(71) Applicant: Kevin Michael Ruml, Plano, TX (US)

(72) Inventor: Kevin Michael Ruml, Plano, TX (US)

(21) Appl. No.: 17/469,256

(22) Filed: Sep. 8, 2021

(51) Int. Cl. E05B 15/02

(52) U.S. Cl. CPC E05B 15/024

(57) ABSTRACT

A strike plate for a door in one manufactured piece comprising additional holes for the mounting screws to allow the vertical adjustment of the strike plate so that the aperture for the bolt or latch is moved to account for misalignment caused by building settling or as a consequence of age or other factors.

### BACKGROUND OF THE INVENTION

### Field of Invention

The present invention relates to door strikes for latches and bolts.

### SUMMARY OF THE INVENTION

A primary object of the present invention is to provide a door strike plate, in one piece for simplicity of construction that can be economically manufactured, that once installed can be adjusted later to allow the aperture for the latch or bolt to be moved vertically if misalignment occurs.

Another object is to allow an existing common strike plate of a design unlike the present invention which does not have the additional mounting screw holes, to be replaced to allow the adjustment of the latch or bolt aperture due to misalignment while giving extra distance from existing mounting screw holes to the new mounting screw holes to prevent merging of the screw holes and sacrificing the integrity of the door jamb where the strike plate is mounted. Possibly only a small expansion of the mortise in the required direction is required, using simple tools such as a wood chisel.

### BRIEF DESCRIPTION OF THE DRAWINGS

FIGURE 1 is a front elevational view of a strike plate according to the present invention

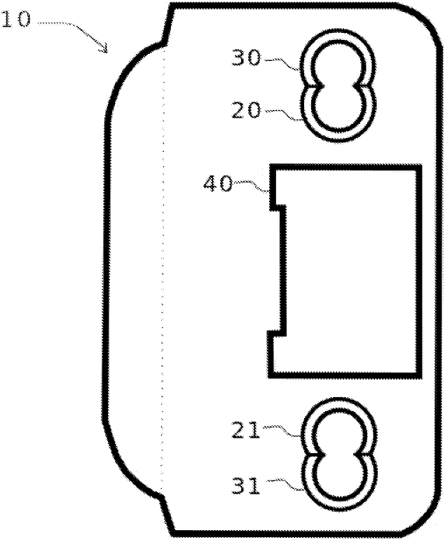

### DETAILED DESCRIPTION OF THE PREFERRED EMBODIMENT

Referring now to the drawing, a strike plate according to the present invention is referred to generally by reference numeral 10. Strike plate assembly 10 is for mounting on a door frame, not shown. The door frame forms a clearance hole for receiving the strike plate assembly.

Strike plate 10 is affixed to the door frame by screws inserted through countersunk holes 20 and 21. The interior countersunk holes 20 and 21 nearest the latch or bolt aperture correspond to those found in conventional door strike plates, so the outer countersunk holes 30 and 31 allow the strike plate latch or bolt aperture 40 to be adjusted vertically either higher or lower as needed when they are used for mounting screws in conjunction with one or the other of the original screws, only requiring one new bore hole and allowing enough distance from the original bore hole that they cannot merge due to close proximity which would compromise the integrity of the door jamb for adequately holding the strike plate mounting screw in place. The countersunk holes are overlapping so the opening is not just a straight slot, which allows the mounting screws to hold it in that specific position.

I do not wish to be understood as limiting myself to the particular form of embodiment shown, as variations thereof are possible without departing from or exceeding the scopes of my claims.

Adjustable strike plates have been proposed before. However, such strike plates have generally proven commercially unsuccessful because they have been too complex and cost appreciably more than single-piece non-adjustable strike plates. Specifically, adjustable strike plates have been comprised of multiple pieces to allow the latch or bolt aperture position to be adjusted.

The invention claimed is:

1. I claim a one-piece door strike plate comprising:
multiple countersunk screw holes on each side of the latch or bolt aperture for mounting the plate to the door frame in multiple positions by providing additional locations for the mounting screws to allow for vertically adjusting for the misalignment of the latch or bolt aperture,
with the screw holes being overlapping to have them close enough to have a small latch or bolt aperture displacement yet still form a way of having the strike plate held in a particular position by the mounting screws without sliding to a different vertical position,
the aforesaid multiple countersunk screw holes are all of the same characteristics so can be implemented during manufacture using the exact same process as currently manufactured strike plates to reduce manufacturing complexity and costs.
